(19) United States
(12) Patent Application Publication
(10) Pub. No.: US 2024/0083289 A1
(43) Pub. Date: Mar. 14, 2024

(54) SYSTEMS AND METHODS FOR ELECTRIC VEHICLE CHARGING COMMUNICATIONS

(71) Applicant: Rivian IP Holdings, LLC, Plymouth, MI (US)

(72) Inventors: Tyler Jennings Bennett, Long Beach, CA (US); Kyle Robert Underhill, Los Angeles, CA (US); Nilesh Darade, Milpitas, CA (US); Chakravarthy Allamsetty, San Jose, CA (US); Tyler Jay Erikson, Torrance, CA (US)

(21) Appl. No.: 17/944,325

(22) Filed: Sep. 14, 2022

(51) Int. Cl. B60L 53/66; B60L 53/18; B60L 53/30

(52) U.S. Cl. CPC B60L 53/665; B60L 53/18; B60L 53/305

(57) ABSTRACT

A vehicle charger may be connected to a vehicle by a charging cable, and the charger may determine a mode of communication based on a control signal received from the vehicle over the charging cable, determine payment information based on the mode of communication, and charge the vehicle using the charging cable based on the payment information.

### INTRODUCTION

The present disclosure is directed to managing electric vehicle charging and, more particularly, to chargers capable to managing payment information and charging in multiple ways.

### SUMMARY

The present disclosure is directed to managing vehicle charging, including managing payment information and vehicle-charger communications. For example, it may be desired to provide chargers configured to achieve seamless payment in public, based on a coexistence of standards and protocols, and having fallbacks (e.g., attempts and re-attempts) to ensure a positive user experience. In some embodiments, chargers of the present disclosure are configured to charge vehicle that support digital communication and vehicles that do not support digital communications, as well as vehicles that may be configured for plug-and-charge charging.

In some embodiments, the present disclosure is directed to a method for managing vehicle charging of a vehicle coupled to a charger by a charging cable. The method includes determining a mode of communication based on a control signal transmitted over the charging cable, determining payment information based on the mode of communication, and causing the charger to charge the vehicle using the charging cable based on the payment information. In some embodiments, determining the mode of communication includes determining whether to use analog or digital communication for vehicle-charger communications. In some embodiments, determining the mode of communication includes determining whether digital communication is established or not.

In some embodiments, determining the mode of communication includes setting a charging duty cycle to a first setting and determining whether signal level attenuation characterization (SLAC) started. For example, if SLAC has not started, the mode of communication includes analog communication and, if SLAC has started, the mode of communication includes digital communication.

In some embodiments, determining the payment information includes accessing a remote application using a communications interface, and receiving a remote start signal from the remote application in response to payment being approved.

In some embodiments, the method includes identifying the vehicle and, based on identifying the vehicle, determining the payment information by accessing the payment information from the vehicle using the charging cable. For example, the vehicle may be identified using digital communication (e.g., power-line communication (PLC)).

In some embodiments, determining the payment information includes identifying the vehicle as corresponding to a payment application and, if the vehicle is identified as corresponding to the payment application, determining payment information for the vehicle by accessing the payment application. The payment application may implemented or accessed the charger, and may allow saved payment information to be used to streamline a charging session.

In some embodiments, the method includes determining the vehicle is coupled to the charger by the charging cable, and transmitting a first signal to the vehicle. In some embodiments, the control signal is a response to the first signal (e.g., using proximity and ground terminals of a connector of the charging cable). In some embodiments, the method includes identifying, detecting, or otherwise determining a transition from an unplugged mode corresponding to a vehicle being unplugged from a charger to the standby mode.

In some embodiments, the present disclosure is directed to a method for managing vehicle charging that includes transitioning among modes. In some embodiments, the method includes transitioning from a standby mode corresponding to a vehicle being plugged to a charger by a charging cable but not ready for charging, to a ready mode. In some embodiments, the method includes determining whether to use an analog communications protocol or a digital communications protocol for vehicle-charger communications. In some embodiments, the method includes transitioning from the ready mode to the standby mode, if the analog communication protocol is determined to be used. In some embodiments, the method includes remaining in the ready mode. In some embodiments, if the digital communication protocol is determined to be used, the charger receives payment information while in the ready mode.

In some embodiments, the ready mode corresponds to the vehicle being plugged in and a first duty cycle being applied by the charger to the charging cable. In some embodiments, determining whether to use the analog communications protocol or the digital communications protocol includes attempting to establish a secured connection between the vehicle and the charger using digital communications. For example, in some embodiments, if the secured connection is not established, the method includes determining payment information while in the standby mode. In some embodiments, the method includes transitioning to the ready mode based on the payment information. For example, charging may be managed with analog communications in the ready mode.

In some embodiments, the ready mode corresponds to the vehicle being plugged in and a first duty cycle being applied by the charger to the charging cable. In some embodiments, determining whether to use the analog communications protocol or the digital communications protocol includes attempting to establish a secured connection between the vehicle and the charger using digital communications. For example, in some embodiments, if the secured connection is established, the method includes determining payment information while in the standby mode. In some embodiments, the method includes transitioning to the ready mode based on the payment information. For example, charging may be managed with digital communications in the ready mode.

In some embodiments, the ready mode corresponds to the vehicle being plugged in and a first duty cycle being applied by the charger to the charging cable. In some embodiments, determining whether to use the analog communications protocol or the digital communications protocol includes attempting to establish a secured connection between the vehicle and the charger using digital communications. For example, in some embodiments, if the secured connection is established, the method includes identifying the vehicle and the payment information corresponding to the vehicle. In some embodiments, the method includes achieving plug-and-charge (PnC) based on the payment information, and charging is managed with digital communications in the ready mode.

In some embodiments, the method includes determining whether the payment information has been received while in the standby mode and, if the payment information has been received, transitioning from the standby mode to the ready mode. In some embodiments, charging is managed with analog communications in the ready mode.

In some embodiments, the present disclosure is directed to a system for providing alternating current (AC) vehicle charging. The system, which may be a vehicle charger, includes a charging interface configured to interact with a vehicle using a charging cable and control circuitry. The control circuitry is configured to determine a mode of communication based on a control signal transmitted over the charging cable, determine payment information based on the mode of communication, and cause the charger to charge the vehicle using the charging cable based on the payment information.

In some embodiments, the control circuitry is configured to determine the mode of communication by determining whether to use analog or digital communication for vehicle-charger communications. In some embodiments, the control circuitry is configured to determine the mode of communication by setting a charging duty cycle at the charging interface to a first setting, and determining whether signal level attenuation characterization (SLAC) started. For example, (i) if SLAC has not started, the mode of communication may include analog communication and (ii) if SLAC has started, the mode of communication may include digital communication. For example, if the charger can establish an internet protocol (TP) connection, then the charger may engage in digital communication with the vehicle over the charging cable.

In some embodiments, the system includes a communications interface linked to a network. In some embodiments, the control circuitry is configured to determine the payment information by accessing a remote application using the communications interface, and receiving a remote start signal from the remote application in response to payment being approved.

In some embodiments, the control circuitry is configured to determine a classification of the vehicle. In some embodiments, the control circuitry is configured to, if the classification matches a predetermined classification, determine the payment information by accessing the payment information from the vehicle using the charging cable.

In some embodiments, the system includes a user interface configured to receive user input and generate a display. In some embodiments, the control circuitry is further configured to determine the payment information by identifying the vehicle as corresponding to a payment application and, if the vehicle is identified as corresponding to the payment application, determining payment information for the vehicle by accessing the payment application.

In some embodiments, the control circuitry is configured to determine a vehicle is coupled to a charger by the charging cable, and transmit a first signal to the vehicle. For example, in some embodiments, the control signal is a response to the first signal.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows a block diagram of several configurations of vehicle-charger communications, in accordance with some embodiments of the present disclosure;

FIG. 2 shows a block diagram of an illustrative charging interface, in accordance with some embodiments of the present disclosure;

FIG. 3 shows a block diagram of an illustrative charging system, in accordance with some embodiments of the present disclosure;

FIG. 4 is a flowchart of an illustrative process for managing charging of an electric vehicle, in accordance with some embodiments of the present disclosure;

FIG. 5 is a flowchart of another illustrative process for managing charging of an electric vehicle, in accordance with some embodiments of the present disclosure; and

FIG. 6 is a flowchart of another illustrative process for managing charging of an electric vehicle, in accordance with some embodiments of the present disclosure.

### DETAILED DESCRIPTION OF THE DRAWINGS

The present disclosure is directed to chargers for electric vehicles, also referred to electric vehicle supply equipment (EVSE), configured to provide charging (e.g., AC charging) to vehicles using analog communication or digital communication depending on the vehicle configuration. For example, in some embodiments, a charger is configured to support charging using multiple communication methods for various vehicle makes or types including legacy vehicles (e.g., which may rely on older technology) on an open charging network, and advanced vehicles that can communicate payment information over the charging cable. In some circumstances, it is desired to provide AC charging using payment information exchanged over the charging cord, integrate payment facilitation with AC charging, allow support of an open network and of both payment-over-cord and legacy vehicles (e.g., payment using the charger, an application or other suitable technique), allow a better customer experience among a charging network, or a combination thereof.

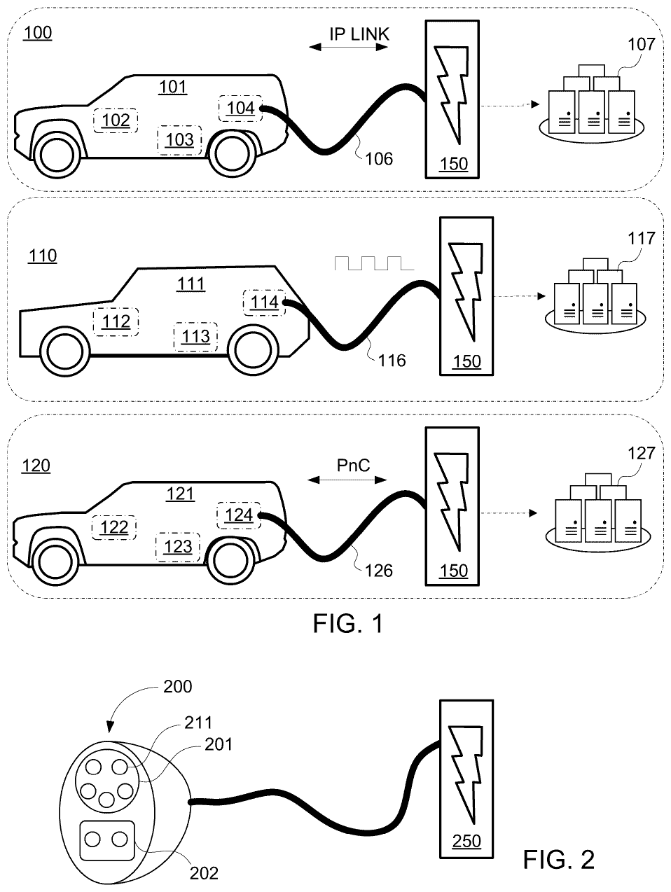

FIG. 1 shows a block diagram of several configurations of vehicle-charger communications, in accordance with some embodiments of the present disclosure. Charger 150, as illustrated, is configured for managing electric vehicle charging in several different ways. Cords 106, 116, and 126 (e.g., charging cables with suitable end connectors) may be same or similar cords (e.g., based on the SAE J1772 standard).

Panel 100 illustrates a configuration in which vehicle 101 is coupled to charger 150 via cord 106, and in which digital communication is used (e.g., via IP link using ISO 15118 or any other suitable protocol for exchanging information), and payment information may be managed via cord 106, an application implemented at charger 150 (e.g., which may communicate with a user device associated with vehicle 101), a remote application, or a combination thereof. For example, when plugged in, vehicle 101 (e.g., control circuitry thereof) and charger 150 (e.g., control circuitry thereof) may perform a transport layer security (TLS) handshake, during which identifications occur (e.g., of vehicle 101, charger 150, or both), certificates are presented, certificates are verified, connection is established, any other suitable processes, or any combination thereof.

Panel 110 illustrates a configuration in which vehicle 111 is coupled to charger 150 via cord 116, and in which analog communication is used (e.g., via signal terminals of the connector, using a duty cycle) and payment information is managed at charger 150. For example, panel 110 illustrates a configuration in which vehicle 111 is configured for charging based on a square wave signal having a duty cycle (e.g., a 12 kHz, −12V to 12V signal). In the arrangement of panel 110, payment information is not transmitted via cord 106. In some embodiments, vehicle information, payment information, and any other information cannot be transmitted between charger 150 and vehicle 111 using cord 116 because vehicle 111 is not configured to communicate via cord 116. In some such circumstances, charger 150 and vehicle 111 may communicate using some other suitable protocol (e.g., via an OBD II port, Bluetooth, WiFi, or other suitable communication type) without using cord 116.

Panel 120 illustrates a PnC configuration, for example, in which vehicle 121 is coupled to charger 150 via cord 126, and in which digital communication is used (e.g., via IP link using ISO 15118 or any other suitable protocol, wherein payment information is transmitted via cord 126). For example, vehicle 121 may be identified by charger 150 (e.g., a digital certificate associated with vehicle 121 may be identified), and payment information may be determined based on the identification.

After a user plugs their vehicle into the charging station (e.g., plugs one of vehicles 101, 111, or 121 into charger 150), the charging station may proceed through a process flow (e.g., based on computer instructions stored in non-transitory computer readable media) to determine which type of charging communication to engage in with the vehicle. For example, this flexibility allows support for payment over the charge cord (e.g., cord 106 or 126), legacy vehicles (e.g., vehicle 111), and other vehicles that might not have same Root Certificates (managed by certificate authorities of a public key infrastructure (PKI)). For example, the process includes selecting a communication method after the vehicle is plugged into charger 150, and allows for vehicles that do not support charging payment integration to still communicate via a fallback method. In a further example, charger 150 may remove the need for a user to pay and plug-in in any specific order or way, allowing more flexibility and adaptability in charging interactions.

FIG. 2 shows a block diagram of illustrative charging interface 200, in accordance with some embodiments of the present disclosure. As illustrated, charging interface 200 of charger 250 may include plugs having electrical terminals. For example, charging interface 200 includes electrical terminals for AC charging (e.g., plug portion 201) and DC charging (e.g., plug portion 202). It will be understood that the chargers of the present disclosure may be configured for any suitable charging, and may include any suitable connector type (e.g., J1772 type connectors, combined charging system (CCS) type connectors, any other suitable connector, or any combination thereof). To illustrate, plug portion 201 includes electrical terminals 211 that may include, for example, terminals for AC charging, a ground, terminals for transmitting signals (e.g., a pulse signal), any other suitable terminals, or any combination thereof. For example, some of electrical terminals 211 of charging interface 200 may be configured to provide AC charging (e.g., a line and a neutral), and some of electrical terminals 211 of charging interface 200 may be used to transmit signals between a vehicle and charger 250. In a further example, electrical terminals 211 may include a ground, a proximity pin (e.g., to determine whether the connector is engaged), and a pilot pin (e.g., to transmit a square wave) for facilitating communication and/or sensing.

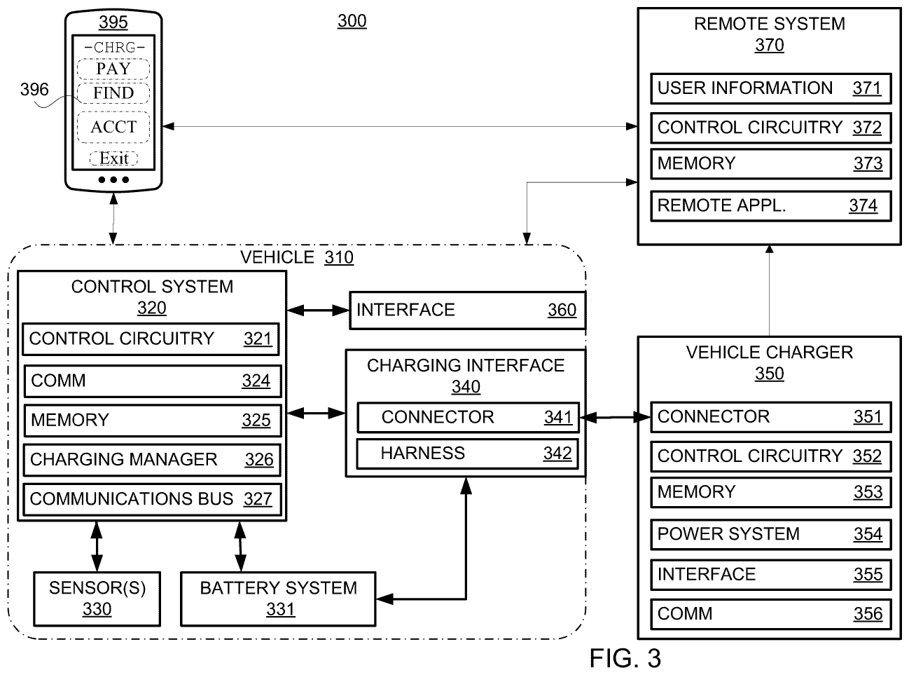

FIG. 3 shows a block diagram of illustrative charging system 300, in accordance with some embodiments of the present disclosure. As illustrated, charging system 300 includes vehicle 310, vehicle charger 350, remote system 370, and device 395. Vehicle 310, as illustrated, includes control system 320, charging interface 340, battery system 331, sensors 330, and interface 360.

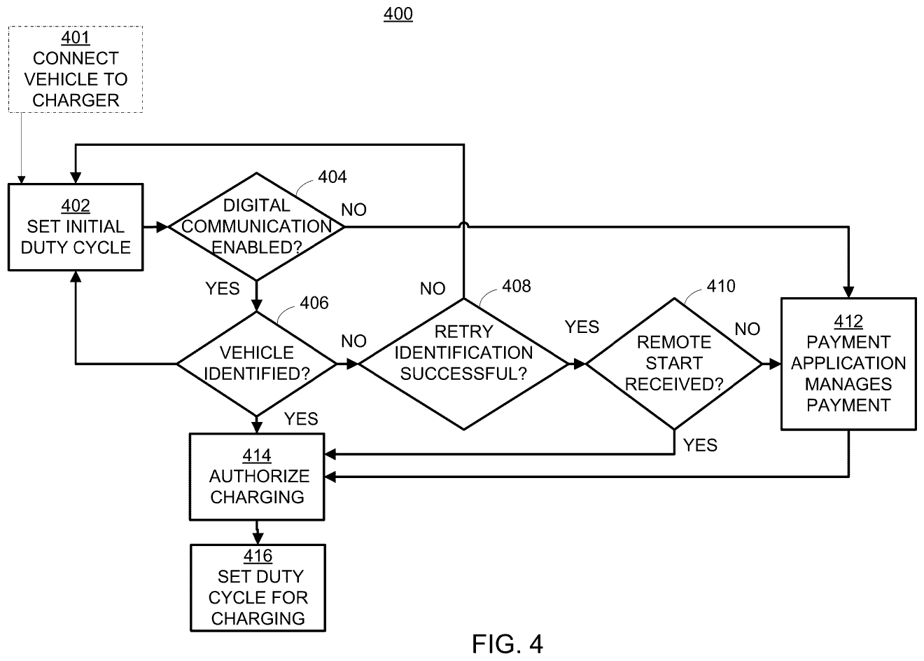

Control system 320, as illustrated, includes control circuitry 321 (e.g., as implemented by one or more electronic control units (ECUs)), memory 325 (e.g., configured to store computer instructions), communications interface 324 (comm 324), communications bus 327, and optionally charging manager 326. Control circuitry 321 may include a processor, a communications bus (e.g., in addition to or instead of communications bus 327), memory (e.g., in addition to or instead of memory 325), power management circuitry, a power supply, any suitable components, or any combination thereof. Memory 325 may include solid state memory, a hard disk, removable media, any other suitable memory hardware, or any combination thereof. In some embodiments, memory 325 is non-transitory computer readable media configured to store computer instructions that, when executed, perform at least some steps of any of process 400, process 500, or process 600 described in the context of FIGS. 4-6. In some embodiments, instructions are preprogrammed into memory 325, memory of one or more ECUs, or a combination thereof, for performing diagnostics, determining vehicle information, determining or receiving charger information, managing payment information, or a combination thereof (e.g., as performed by charging manager 326). In some embodiments, the instructions are loaded or otherwise provided to control circuitry 321 to manage charging. To illustrate, charging manager 326 may be implemented by control circuitry 321, operate separately but in communication with control circuitry 321 (e.g., via communications bus 327), or a combination thereof.

Control system 320 may include an antenna and other control circuitry, or any combination thereof, and may be configured to access the internet, a local area network, a wide area network, a Bluetooth-enable device, an NFC-enabled device, any other suitable device using any suitable protocol, or any combination thereof. In some embodiments, control system 320 includes or otherwise is coupled to interface 360, which may include, for example, a screen, a touchscreen, a touch pad, a keypad, one or more hard buttons, one or more soft buttons, a microphone, a speaker, any other suitable components, or any combination thereof. For example, in some embodiments, interface 360 includes all or part of a dashboard, including displays, dials and gauges (e.g., actual or displayed), soft buttons, indicators, lighting, and other suitable features. In a further example, interface 360 may include one or more hard buttons arranged at the exterior of the vehicle, interior of the vehicle (e.g., at the dash console), or at a dedicated keypad arranged at any suitable position. In a further example, interface 360 may be configured to receive input from device 395, haptic input from a user, or both.

Comm 324 may include one or more ports, connectors, input/output (I/O) terminals, cables, wires, a printed circuit board, control circuitry, any other suitable components for communicating with other units, devices, or components, or any combination thereof. In some embodiments, control system 320 (e.g., ECUs of control circuitry 321) is configured to control a drivetrain (e.g., control an engine, electric motor, transmission, brake), cooling system, cabin air system, braking system, autonomous control system, steering system, suspension system, control or manage a battery system (e.g., battery system 331), determine status information of the vehicle or components thereof, communicate with other units, identify an occupant (e.g., based on device 395), identify a user device (e.g., device 395), determine payment information (e.g., via an application of charging manager 326), perform any other suitable actions, or any combination thereof. In some embodiments, comm 324, interface 360, or both, may be configured to send and receive wireless information between control system 320 and external devices such as, for example, network devices (e.g., a server, a WiFi access point, remote system 370), device 395 (e.g., a user device such as a smart phone), keyfobs, any other suitable devices, or any combination thereof. In some embodiments, communications bus 327 is integrated with comm 324 (e.g., communicatively coupling control circuitry 321, charging interface 340, and interface 360). In some embodiments, communications bus 327 may be coupled to comm 324. Communications bus 327 may include or otherwise be coupled to terminals of connector 341 of charging interface 340, terminals of control circuitry 321, charging manager 326, any other suitable components, or any combination thereof.

Battery system 331 may include, for example, a vehicle battery pack that may include a plurality of battery cells. For example, battery system 331 may include battery cells, busbars, current collectors, enclosures, DC bus cables or otherwise conductors, contactors, switches, sensors and instrumentation, power electronics, any other suitable components, or any combination thereof. In a further example, battery system 331 may provide a DC voltage to charging interface 340, buses thereof, provide any suitable voltage to any suitable system of vehicle 310 (e.g., control system 320).

As illustrated, device 395 includes four soft buttons 396, each corresponding to a particular function associated with diagnostics for vehicle 310. When one of soft buttons 396 is selected, control circuitry of device 395 may receive a signal that corresponds to the button press (e.g., from an electrical switch or sensor coupled to the button), and in response generate a message or otherwise signal for transmitting to a communications interface of vehicle 310 (e.g., comm 324). In an illustrative example, the user may select an application (e.g., a payment application, a charging application, a vehicle identification application with a user account) implemented on device 395 to manage indications generated by control system 320. As illustrated, soft buttons 396 include a “PAY” button (e.g., to enter or access stored payment information), a “FIND” button (e.g., to identify locations of one or more compatible locations), and an “ACCT” button (e.g., to manage user account information, vehicle identification, or other information), to provide respective commands, information, or queries to control system 320. In some embodiments, any of soft buttons 396 or functionality of device 395 may be implemented using interface 360, control system 320, or a combination thereof. For example, a user may manage indications at interface 360 of vehicle 310 (e.g., such as a touchscreen at the dash console) rather than on a separate user device (e.g., device 395).

Vehicle charger 350 may be located at a position accessible along a route (e.g., roadside, in a parking lot, at a facility, or otherwise accessible to vehicle 310). As illustrated, vehicle charger 350 includes connector 351 (e.g., which may include a charging cable and one or more end connectors), control circuitry 352, memory 353, power system 354, interface 355, and communications interface (comm) 356. For example, connector 351 of vehicle charger 350 may be connected to connector 341 (e.g., by plugging the mating connectors together to engage electrical pins). In some embodiments, vehicle charger 350 may be or include a module configured to plug into connector 341, transmit wireless or wired signals to remote processing equipment (e.g., of remote system 370 or device 395). Control circuitry 352 may be configured to process signals from charging interface 340 to, for example, determine vehicle information, determine payment information, charging information, any other suitable information, or any combination thereof. For example, control circuitry 352 may interface to communications bus 327, charging manager 326, or both via charging interface 340. In some embodiments, vehicle charger 350 is associated with one or more digital certificates linked to a Vehicle-to-Grid Root Certificate Authority (V2G Root CA), supply equipment communication controller (SECC), charge point operator (CPO) certificate, any other suitable digital certificate, or any combination thereof. For example, interface 355 may include a screen, touchscreen, keypad, hard buttons, soft buttons, an audio system (e.g., a speaker and microphone), camera, credit card payment interface, card payment interface (e.g., gift card, prepaid card, ID card, voucher), cash payment interface, pay by phone interface, any other suitable components or features, or any combination thereof.

Comm 356 may include one or more ports, connectors, input/output (I/O) terminals, cables, wires, a printed circuit board, control circuitry, any other suitable components for communicating with other units, devices, or components, or any combination thereof. In some embodiments, comm 356 is configured to communicate with vehicle 310 or components thereof, communicate with other chargers, communicate with remote system 370, identify an occupant (e.g., based on device 395), identify a user device (e.g., device 395), receive payment information (e.g., from remote system 370, device 395, or other suitable device), perform any other suitable actions, or any combination thereof. For example, charger 350 may be configured to access a remote application (e.g., implemented at remote system 370) using comm 356, and receive a remote start signal from the remote application in response to payment being approved. In a further example, charger 350 may be configured to access the remote application (e.g., implemented at remote system 370) using comm 356, and authenticate payment information provided by the user, associated with the user, associated with vehicle 310 (e.g., based on control circuitry 352 identifying vehicle 310 and an associated account), or a combination thereof.

Remote system 370 may include a server, cloud storage, or other network device configured to communicate over a communications network (e.g., with vehicle 310, device 395, vehicle charger 350, any other suitable device, or any combination thereof). As illustrated, remote system 370 includes user information 371, control circuitry 372, memory 373, and remote application 374, although it will be understood that remote system 370 may include one or more systems, each having any suitable components. In some embodiments, remote application 374 is configured to manage payment information, user account information, security information, or a combination thereof, and communicate with vehicle charger 350, vehicle 310, or both to ensure that vehicle 310 can be charged by vehicle charger 350 (e.g., is allowed based on payment information, compatibility, or both). For example, in some circumstances, a user of vehicle 310 may connect vehicle 310 to vehicle charger 350 and then enter payment information directly to vehicle charger 350 (e.g., using a credit card, debit card, cash, or other suitable transaction type). If needed, vehicle charger 350 may communicate with remote system 370 (e.g., which may include or be linked to financial account information of the user) to verify payment information, authorize payment information, or otherwise determine payment information. In a further example, in some circumstances, a user of vehicle 310 may connect vehicle 310 to vehicle charger 350, and vehicle 310 and vehicle charger 350 may initiate digital communication. Vehicle charger 350 may provide one or more security certificates (e.g., a SECC certificate, CPO certificate, or other suitable information) to vehicle 310 to establish digital communication (e.g., a TLS handshake) via charging cable coupling connector 341 to connector 351. In turn, vehicle 310 may verify the security certificates from vehicle charger 350, and then transmit another certificate to vehicle charger 350 indicating authorization for charging. Authorization may be based on payment information associated with a user account of the user, which may be managed by remote system 370 (e.g., external identification means (EIM), associated with a mobility operator (MO), or by any other suitable technique)).

In an illustrative example, vehicle 310 may include an on-board charging system that includes charging manager 326 and charging interface 340. Charging manager 326 may be associated with control circuitry of a particular ECU (e.g., of control circuitry 321), distributed among ECUs (e.g., ECUs connected by communications bus 327), a separate controller, any other suitable control circuitry, or any combination thereof. In some embodiments, charging manager 326 and charging interface 340 may be configured to engage in analog communication (e.g., with vehicle charger 350), digital communication (e.g., with vehicle charger 350), transmit and/or receive payment information, transmit and/or receive charging parameters, transmit and/or receive electric power, any other suitable function, or any combination thereof.

FIGS. 4-6 are flowcharts of illustrative processes 400, 500, 600, and 700 for managing charging of an electric vehicle, including determining payment information. These processes allow a charger (e.g., of a charger network) to offer a seamless plug-in experience with vehicles of a particular make, while also still allowing traditional AC charging on other vehicles using other payment techniques (e.g., External Payment). The processes allow seamless plug-in and application-based payment to other customers (e.g., having vehicles of any make) without requiring them to perform plugging, paying, or other steps in any specific order, which may allow for a more user-friendly experience. For example, AC charging may be achieved via basic communication (e.g., pilot duty cycle/voltage and proximity signals), seamless payment via digital communication over the cable (e.g., based on an ISO 15118 IP connection), or any other suitable methods. Processes 400-600 may allow these different communication protocols to coexist to improve interoperability of the charger. In an illustrative example, processes 400-600 may be implemented by vehicle charger 350 or any suitable portion of charging system 300, charger 150 of FIG. 1, or any other suitable system. In some embodiments, a single charger is capable of performing any or all of processes 400-600.

FIG. 4 is a flowchart of illustrative process 400 for managing charging of an electric vehicle, in accordance with some embodiments of the present disclosure. In an illustrative example, process 400 may correspond to authenticating a vehicle of a particular make (e.g., having certificates associated with the charger) using digital communication, with a return to analog communication for charging (e.g., based on J1772 square wave communication using a duty cycle). For example, process 400 may be used if PnC is not used for payment information and other communication over the charging cable. In a further example, process 400 may include using analog communication to control charging, and using digital communication to identify the vehicle (e.g., and optionally payment information based on an account associated with the identified vehicle). Payment information may be determined based on identifying the vehicle (e.g., via PLC), or may be provided using a payment application implemented on the charger or a user device (e.g., which may communicate with a remote system to authenticate payment information).

Step 401 includes connecting the vehicle to the charger. For example, a user may park the vehicle near the charger, undock a charging cable with a connector from the charger, and plug the connector into a charging port of the vehicle. The cable may include, for example, terminals (e.g., pins, sockets, or other suitable terminations) proximity determination, communications, AC charging (e.g., a five-pin connector), DC charging (e.g., a combined connector having seven pins, a two pin connector, or any other suitable connector), or a combination thereof. For example, when plugged in, electrical signals at suitable terminals (e.g., a voltage across a ground terminal and proximity pilot terminal) may indicate to the vehicle, charger, or both, that the vehicle and charger are connected.

Step 402 includes setting an initial duty cycle at suitable pins of the connector to provide at least some communication between the charger and the vehicle. In some embodiments, the charger may provide a nominal duty cycle (e.g., 5% or other suitable duty cycle) to enable communication between the vehicle and the charger. In some embodiments, the duty cycle indicates to the vehicle that the charger is connected. In some embodiments, for example, one or more terminals (e.g., a proximity terminal and a ground) may be used to determine that a vehicle is connected to the charger, and the charger provides charging via pins of a connector of the charging cable.

Step 404 includes determining whether digital communication is enabled or otherwise achieved. In some embodiments, step 404 includes establishing or attempting to establish a communications channel using an internet protocol (IP) connection between the vehicle and the charger. For example, the charger may determine whether signal level attenuation characterization (SLAC) has been enabled to establish the IP connection. In a further example, digital communication may be implemented using ISO 15118 (e.g., secured communication), DIN 70121 (e.g., non-secured communication), or any other suitable protocol/standard for digital communication. In a further example, Power-Line Communication (PLC) may be used for charger-vehicle digital communications, analog communications, or both (e.g., using a control pilot terminal). Depending upon the vehicle type, functionality, vehicle settings, charger settings, or a combination thereof, digital communication may be, but need not be, enabled. If digital communication is not enabled, and thus payment information might not be able to be transferred over the charging cable or determined based on identifying the vehicle, the charger may proceed to step 412 to prompt the user for payment information (e.g., using a payment application associated with an interface of the charger). In some embodiments, step 404 includes initiating a charging session, which may include identifying the charger, identifying the vehicle, linking the charger to the vehicle (e.g., an ECU thereof), any other suitable functions, or any combination thereof.

Step 406 includes identifying the vehicle, or otherwise determining if the vehicle belongs to a set of vehicles configured to communicate with the charger. For example, if the vehicle is identified, payment information may be retrieved based on an existing use account (e.g., linked to a financial institution). In some embodiments, the charger is configured to recognize the vehicle, a user device associated with the vehicle, or both and then identify payment information based on the vehicle.

Step 414 includes authorizing charging of the vehicle by the charger. For example, if the vehicle is identified at step 406, and payment information is retrieved, then the charger may authorize charging at step 414 and proceed to step 416. Step 416 includes setting a duty cycle using analog communication to facilitate charging of the vehicle (e.g., based on a duty cycle at J1772 terminals). To illustrate, at step 414, the charger may retrieve a user account linked to the vehicle, and receive authorization for charging based on the account (e.g., charging has been prepaid, charging is authorized based on existing payment information). For example, because the payment information is verified at step 414 based on identifying the vehicle, payment information need not be transmitted via the charging cable.

Step 408 includes attempting to retry vehicle identification using digital communication. For example, if the vehicle is not identified at step 406, and payment information is not yet retrieved or authorized, then the charger may re-attempt to identify the vehicle at step 408 (e.g., returning to step 402, 404, and/or 406). In some embodiments, the charger is configured to make a predetermined number of attempts to identify the vehicle, each having an associated time duration (e.g., a predetermined timeout may be specified for each attempt).

Step 410 includes determining whether a remote start signal has been received. For example, during attempts to identify the vehicle at step 408, if subsequently identified (e.g., an attempt after the first attempt), the charger may be able to then confirm payment information and proceed to step 414 and then 416. At step 410, if the remote start signal has not been received (e.g., payment information incomplete, insufficient, or otherwise not authorized), then the charger may proceed to step 412 to prompt the user for payment information (e.g., at an interface of the charger). For example, the charger may implement a payment application at step 412 (e.g., linked to a remote system to authorize payment), and then provide the remote start signal to authorize charging at step 414.

In an illustrative example, if digital communication is not enabled at step 404 or a remote start signal is received at 410, process 400 may include vehicle charging at step 416 using communication via J1772. At step 404, if digital communication is enabled, the system may identify the vehicle (e.g., an OEM, make, model, VIN, user account, digital certificate, and/or any other identifying information) at step 406 using digital communications (e.g., via PLC) to and then return analog communication using J1772 (e.g., at step 416, after payment information is confirmed, and remote start is received at step 410). For example, process 400 may allow for communication retry, payment information retry, timeouts, and application-based payment if the vehicle not identified at step 406 or payment is not facilitated using digital communication over the charging cable, to ensure the right customer experience.

In an illustrative example, the charger may determine a mode of communication based on a control signal transmitted over the charging cable at step 404, and determine payment information based on the mode of communication at steps 406 and 414 (e.g., fi the mode is digital), or step 412 (e.g., if the mode is analog rather than digital). At step 416, the charger may charge the vehicle using the charging cable based on the payment information (e.g., control circuitry 352 may cause power system 354 to charge vehicle 310 over the charging cable). In some embodiments, connector 351 may be a charging interface configured to interact with a vehicle using a charging cable (e.g., charge vehicle 310 from power system 354). For example, control circuitry 352 may cause the charging interface to charge vehicle 310 from power system 354.

In some embodiments, a charger may transitioning from a standby mode at step 401 corresponding to a vehicle being plugged to a charger by a charging cable but not ready for charging, to a ready mode at step 402. The charger may determine whether to use an analog communications protocol or a digital communications protocol for vehicle-charger communications at step 404. If the analog communication protocol is determined to be used (e.g., digital communication cannot be established), the charger may transition from the ready mode to the standby mode at steps 408-412 so that payment may be provided. If the digital communication protocol is determined to be used at step 404, the charger may remain in the ready mode or return to the standby mode and receive payment information over the charging cable at steps 406 and 414.

In an illustrative example, a charger may be configured to achieve modes including an unplugged mode, a standby mode, a ready mode, a charging mode. To illustrate, step 401 may include transitioning from the unplugged mode to the standby mode (e.g., plugged but not ready for significant charging). Step 402 may include transitioning to the ready mode, whereby an initial duty cycle may be set. Step 404 may include remaining in the ready mode as SLAC is attempted (e.g., digital communication is attempted). Step 406 may include remaining in the ready mode, as the vehicle is identified (e.g., the charger may return to the standby mode once the vehicle is identified). Step 408 may include transitioning to the standby mode if the vehicle is not identified or otherwise payment information has not been determined. Steps 410 and 412 may be performed in the standby mode (e.g., while the charger is waiting for payment information from the user). Transitioning from step 414 to step 416 may include transitioning from the standby mode to the ready mode or remaining in the ready mode.

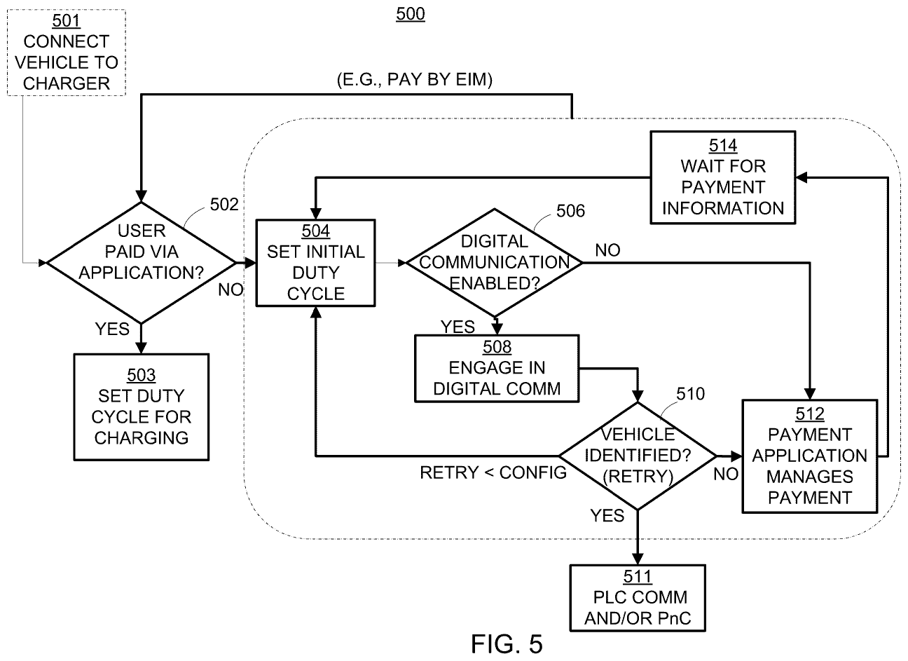

FIG. 5 is a flowchart of illustrative process 500 for managing charging of an electric vehicle, in accordance with some embodiments of the present disclosure. In an illustrative example, process 500 may correspond to authenticating a vehicle of a particular make (e.g., having certificates associated with the charger) using digital communication, and using analog communication for charging other vehicles (e.g., based on J1772 square wave communication using a duty cycle). For example, process 500 may be used to achieve PnC or external payment and duty-cycle-based communication for charging, depending on the vehicle type. In a further example, process 500 may include determining whether to use digital or analog communication for transmitting payment information and charging (e.g., decide between using ISO15118 or J1772 communication). Process 500 may include first determining whether the user has paid using an application at a user device or the charger and, if so, proceeding with duty-cycle based charging. If the user has not paid yet, the charger proceeds to attempt SLAC, and if digital communication is initiated, the charger may identify the vehicle and determine payment information, and then proceed to manage charging the vehicle using PLC communication (e.g., PnC or other suitable technique). If the vehicle is not identified, or otherwise payment information is not determined, then the charger may prompt the user to provide payment information and/or re-attempt to establish digital communication.

Step 501 includes connecting the vehicle to the charger. For example, a user may park the vehicle near the charger, undock a charging cable with connector from the charger, and plug the connector into a charging port of the vehicle. The cable may include, for example, terminals (e.g., pins, sockets, or other suitable terminations) proximity determination, communications, AC charging (e.g., a five-pin connector), DC charging (e.g., a combined connector having seven pins, a two pin connector, or any other suitable connector), or a combination thereof. For example, when plugged in, electrical signals at suitable terminals (e.g., a voltage across a ground terminal and proximity pilot terminal) may indicate to the vehicle, charger, or both, that the vehicle and charger are connected.

Step 502 includes determining whether the user has paid using an application. For example, in some embodiments, the user may provide payment information using external identification means (EIM). Step 502 may include the use providing payment information using an interface of the charger or otherwise not by transmitting payment information over the charging cable (e.g., a credit card interface, cash interface, voucher, code, pay by phone, or other suitable interface). If payment is determined to have been received at step 502, the charger need not attempt to establish digital communication with the vehicle.

Step 503 includes setting a duty cycle using analog communication to facilitate charging of the vehicle. For example, at step 502, if the user has paid using an interface of the charger, or using another external application that does not include the charger identifying the vehicle (e.g., and transmitting payment over the charging cable), then the charger set the duty cycle for charging using an analog protocol (e.g., using J1772). To illustrate, the charger may set the duty cycle to 80% (e.g., corresponding to 48 Amps) in a “ready mode” or “charging mode” (e.g., where a contactor or switch is closed to transmit charging current to the vehicle).

Step 504 includes setting an initial duty cycle at suitable pins of the connector to provide at least some communication between the charger and the vehicle. In some embodiments, for example, step 504 includes setting a duty cycle to 5%, or any other relatively low percentage (e.g., less than a charging duty cycle), so that information may be transmitted using the charging cable. To illustrate, in some embodiments, by setting the initial duty cycle at step 504, the charge may be enabled to proceed through steps 506, 508, 510, 512, and 514.

Step 506 includes determining whether digital communication is enabled or otherwise achieved. In some embodiments, for example, step 506 includes establishing or attempting to establish a communications channel using an IP connection between the vehicle and the charger. For example, the charger may determine whether SLAC has been enabled to establish the IP connection. Depending upon the vehicle type, functionality, vehicle settings, charger settings, or a combination thereof, digital communication may be, but need not be, enabled.

Step 508 includes engaging in digital communication between the vehicle and the charger. In some embodiments, for example, step 508 includes communicating using a TLS standard for engaging in secure communications (e.g., using the IP connection of step 506). Some vehicles plugged into the charger may be configured for analog-only communication (e.g., some legacy vehicles), some may be configured to digital communication and identification (e.g., a subset of makes/models authorized by the charger), and some vehicles may be configured to achieve PnC. Digital communication may include sending and receiving digital signals (e.g., accordingly to ISO 15118 protocols) to identify a vehicle, transmit payment information, transmit vehicle information, transmit charger information, exchange digital certificates, transmit any other suitable information, or any combination thereof.

Step 510 includes identifying the vehicle, or otherwise determining if the vehicle belongs to a set of vehicles configured to communicate with the charger. In some embodiments, step 510 includes attempting to retry vehicle identification using digital communication, or otherwise waiting (e.g., for a predetermined time duration) for digital communication to be enacted. If the vehicle is identified, the charger may access available payment information associated with a user account, for which payment information may already be authorized or otherwise provided. The transition from step 510 to 512 may be attempted a predetermined number of times (e.g., three times or any other suitable integer). For example, for each re-attempt, the charger may return to step 504 (e.g., for a number of retries less than a configured threshold). Once the limit of re-attempts has been exhausted (e.g., the vehicle has not been identified or otherwise payment information is not determined), the charger may proceed to step 512.

Step 511 includes authorizing charging of the vehicle by the charger using PLC communication such as by PnC, if the vehicle is identified at step 510. Step 511 may include providing AC charging, DC charging, or a combination thereof to the vehicle based on predetermined settings, without the user needing to provide payment information during the charging event as a separate step (e.g., the user need not use a payment application at the charger).

Step 512 includes managing payment using a payment application (e.g., implemented by the charger). In some embodiments, step 512 includes the charger transitioning to a non-charging state, a zero percent duty cycle (e.g., state E(0%)), opens a charging circuit (e.g., to interrupt any charging or nominal current), or a combination thereof. In some embodiments, step 512 includes the charger displaying a notification to the user, at an interface (e.g., interface 355), to pay using the application, pay using a credit card or cash, pay suing an EIM, or otherwise provide payment information within a time period (e.g., as may be determined at step 514).

Step 514 includes optionally waiting for payment information. If for example, payment information is not provided, or is otherwise insufficient, the charger may wait a predetermined amount of time, or for some other suitable event, for the user to provide payment information using the payment application. For example, the charger may wait for 30 seconds, one minute, two minutes, or any other suitable time period for payment information to be provided. For example, if digital communication is not enabled, the charger may wait for payment information and, when payment information is received, proceed to steps 502 and 503 to begin charging the vehicle (e.g., without establishing digital communication). In a further example, depending on the latency, gating, or otherwise timing, the charger may cycle through steps 514 and 504 and eventually determine that digital communication is enabled at step 506 (e.g., after one or more iterations). For example, the charger may be configured to wait for payment at step 514 for a predetermined time period (e.g., one minute, two minutes, or any other suitable time), attempt a predetermined number of iterations to establish digital communication (e.g., cycle through steps 512, 524 and 540 a predetermined number of times), cease attempting digital communication after a timeout (e.g., 120 seconds or any other suitable time period), or a combination thereof. Once payment information is received, using the payment application (e.g., for vehicle-charger sessions not supporting PnC), the charger may return to step 502 and then step 503 to charge the vehicle using analog communication.

In an illustrative example, the charger may be configured to achieve modes including an unplugged mode, a standby mode, a ready mode, a charging mode. To illustrate, step 501 may include transitioning from the unplugged mode to the standby mode (e.g., plugged but not ready for significant charging). Step 502 may be performed while in the standby mode, and the charger may transition to the ready mode at step 503, once payment information is determined. Step 504 may include transitioning from the standby mode to the ready mode, whereby an initial duty cycle may be set. Step 506 may include remaining in the ready mode as SLAC is attempted (e.g., digital communication is attempted). Steps 508 and 510 may include remaining in the ready mode, as the vehicle is attempted to be identified. Step 512 may include transitioning to the standby mode if the vehicle is not identified or otherwise payment information has not been determined. Steps 512 and 514 may be performed in the standby mode (e.g., while the charger is waiting for payment information from the user). Once payment is received, the charger may transition from the standby mode to the ready mode at steps 502 and/or 503.

In some embodiments, the charger is configured to determine a transition from an unplugged mode corresponding to a vehicle being unplugged from a charger to the standby mode at step 401. In some embodiments, the ready mode corresponds to the vehicle being plugged in and a first duty cycle being applied by the charger to the charging cable at step 402 or step 504. In some embodiments, determining whether to use the analog communications protocol or the digital communications protocol includes attempting to establish a secured connection between the vehicle and the charger using digital communications at step 404 or step 506. The attempt may be repeated at step 408 or steps 512, 514, 504, and 506. If the secured connection is not established, the charger may determine payment information while in the standby mode at step 412 or step 512. In some embodiments, the charger is configured to transition to the ready mode based on the payment information at steps 414 and 416, or steps 502 and 503 (e.g., during which charging is managed with analog communications in the ready mode).

In some embodiments, referencing steps of FIGS. 4-5, the ready mode corresponds to the vehicle being plugged in and a first duty cycle being applied by the charger to the charging cable at step 402 or step 504, and the charger determines whether to use the analog communications protocol or the digital communications protocol by attempting to establish a secured connection between the vehicle and the charger using digital communications at step 404 or step 506. If the secured connection is established, the charger may determine payment information while in the standby mode at steps 406 and 414, or steps 508 and 510. For example, the charger may be configured to transition to the ready mode based on the payment information, and charging is managed with digital communications in the ready mode at steps 510-511.

In some embodiments, the ready mode corresponds to the vehicle being plugged in and a first duty cycle being applied by the charger to the charging cable at step 402 or step 504. In some embodiments, the charger determines whether to use the analog communications protocol or the digital communications protocol by attempting to establish a secured connection between the vehicle and the charger using digital communications at step 404 or step 506. If the secured connection is established, the charger may identify the vehicle and the payment information corresponding to the vehicle at steps 510-511, achieving plug-and-charge (PnC) based on the payment information, with charging is managed with digital communications in the ready mode. In some embodiments, the charger determines whether the payment information has been received while in the standby mode at steps 512 and 514, and if the payment information has been received, the charger transitions from the standby mode to the ready mode at steps 502-503, with charging is managed with analog communications in the ready mode (e.g., using a duty cycle over the J1772 interface).

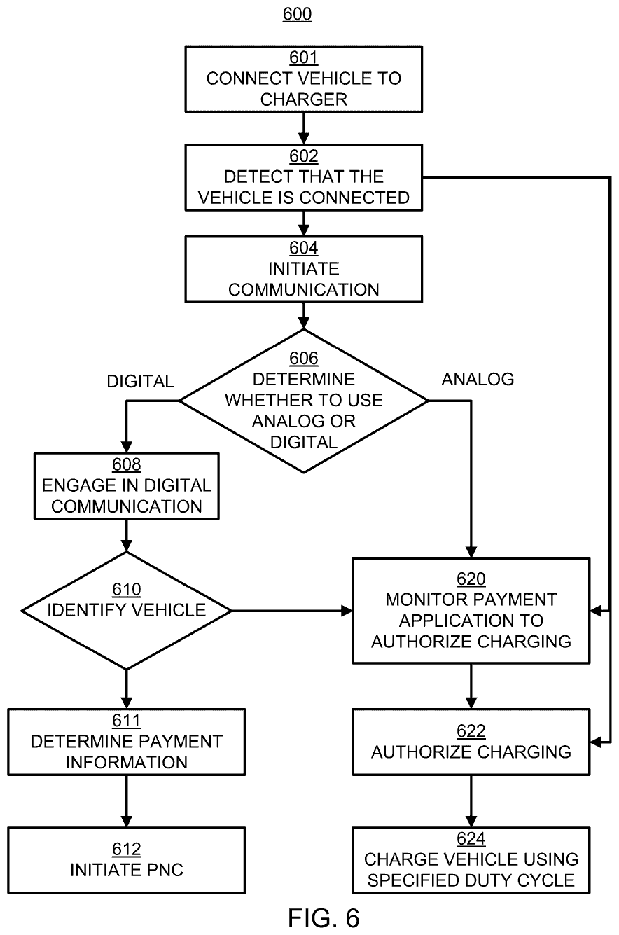

FIG. 6 is a flowchart of illustrative process 600 for managing charging of an electric vehicle, in accordance with some embodiments of the present disclosure. Process 600 may include at least some of the same steps as processes 400 and 500, and may be performed by charger 350 and/or any other suitable system.

Step 601 includes connecting the vehicle and the charger using a charging cable having electrical terminals. For example, connecting the vehicle and charger may include engaging electrical terminals including AC charging terminals, DC charging terminals, signal terminals (e.g., a ground, proximity terminal, and a pilot terminal), any other suitable terminals, or any suitable combination thereof.

Step 602 includes the charger detecting that the vehicle is connected. For example, in some embodiments, the charger detects a signal across a proximity terminal and ground to detect that the vehicle is plugged in. In some embodiments, the charger may include an interface, communications interface, or both, and in some circumstances, payment information may be determined after plugging but before communication is initiated over the charging cable (e.g., the user pays at the charger touchscreen and then plugs the vehicle in). In some such circumstances, the charger may transition to step 622 (e.g., step 620 may be performed prior to step 602). In some embodiments, the charger may transition directly from step 602 to step 620 once the vehicle is plugged in (e.g., without attempting to communication over the charging cable). For example, a user may park the vehicle and select an option at the charger to pay by credit card or cash without an attempt to communicate over the charging cable.

Step 604 includes the charger initiating communication with the vehicle. For example, in some embodiments, the charger may generate a pulse signal having a duty cycle and transmit the signal across the charging cable to the vehicle. In some embodiments, the charger may generate one or more modulated signals to be transmitted over the charging cable (e.g., to initiate communication between PLC modules). The charger may generate analog signals (e.g., pulse width modulation (PWM) duty cycle), digitals signals (e.g., accordingly to ISO 15118, using PLC), or both to determine a mode of communication with the vehicle over the charging cable.

Step 606 includes the charger determining whether to use digital communication or analog communication with the vehicle based on the vehicle's response. For example, the charger may determine whether SLAC has initiated to establish an IP connection using a PLC module. In some embodiments, if a digital connection cannot be established, the charger may proceed to step 620 for payment information to be provided using a payment application (e.g., hosted by the charger), charging to be authorized at step 622, and duty-cycle controlled charging to begin at step 624.

If, at step 606, the charger established digital communication and completes the TLS handshake (e.g., using ISO 15118, or other suitable standard) at step 608, the charger may then attempt to identify the vehicle at step 610 as being associated with a user account for which payment information has been authorized.

If the vehicle is identified at step 610, and payment information is authorized over the charging cable at step 611, then the charger may initiate PnC at step 612. For example, at steps 610 and 612 the charger may identify the vehicle, the user, or both, and an associated account (e.g., a user account). The charger may then, at step 611 determine payment information based on the user account (e.g., pre-entered payment information linked to a financial institution or payment/credit account). In some embodiments, the charger is configured to determine a classification of the vehicle and, if the classification matches a predetermined classification, determine the payment information by accessing the payment information from the vehicle using the charging cable. For example, the vehicle may be classified as being a particular make or model, having a particular subsystem or feature (e.g., a rectifier or inverter for DC charging), or otherwise by classified based on any suitable criterion (e.g., classified as being linked to a payment application to streamline the payment process during charging events).

If the vehicle is not identified, or otherwise payment information is not provided or is not sufficient (e.g., insufficient funds or a blocked/expired payment account), then the charger may transition to step 620 and/or step 622 to prompt the user for payment information using a payment application at the charger or implemented on a user device (e.g., a payment application on a user device associated with the vehicle and/or user account). When authorized, the charger may proceed to charge the vehicle at step 624 using a duty-cycle controlled charging technique.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A method for managing vehicle charging of a vehicle coupled to a charger by a charging cable, the method comprising:
determining, using control circuitry, a mode of communication based on a control signal transmitted over the charging cable;
determining, using the control circuitry, payment information based on the mode of communication; and
causing the charger to charge the vehicle using the charging cable based on the payment information.

2. The method of claim 1, wherein determining the mode of communication comprises determining whether to use analog or digital communication for vehicle-charger communications.

3. The method of claim 1, wherein determining the mode of communication comprises:
setting a charging duty cycle to a first setting; and
determining whether signal level attenuation characterization (SLAC) started, wherein:
if SLAC has not started, the mode of communication comprises analog communication, and
if SLAC has started, the mode of communication comprises digital communication.

4. The method of claim 1, wherein the mode of communication comprises analog communication and wherein determining the payment information comprises:
accessing a remote application using a communications interface; and
receiving a remote start signal from the remote application in response to payment being approved.

5. The method of claim 1, wherein the mode of communication comprises digital communication, the method further comprising:
identifying the vehicle; and
based on identifying the vehicle, determining the payment information by accessing the payment information from the vehicle using the charging cable.

6. The method of claim 1, wherein determining the payment information comprises:
identifying, using the mode of communication, whether the vehicle corresponds to a payment application; and
if the vehicle corresponds to the payment application, determining payment information for the vehicle by accessing the payment application.

7. The method of claim 1, further comprising:
determining the vehicle is coupled to the charger by the charging cable; and
transmitting a first signal to the vehicle, wherein the control signal is a response to the first signal.

8. A method for managing vehicle charging, the method comprising:
transitioning from a standby mode corresponding to a vehicle being plugged to a charger by a charging cable but not ready for charging, to a ready mode;
determining whether to use an analog communications protocol or a digital communications protocol for vehicle-charger communications;
if the analog communication protocol is determined to be used, transitioning from the ready mode to the standby mode; and
if the digital communication protocol is determined to be used, remaining in the ready mode.

9. The method of claim 8, further comprising determining a transition from an unplugged mode corresponding to the vehicle being unplugged from the charger to the standby mode.

10. The method of claim 8, wherein the ready mode corresponds to the vehicle being plugged in and a first duty cycle being applied by the charger to the charging cable, and wherein determining whether to use the analog communications protocol or the digital communications protocol comprises:
attempting to establish a secured connection between the vehicle and the charger using digital communications; and
if the secured connection is not established:
determining payment information while in the standby mode; and
transitioning to the ready mode based on the payment information.

11. The method of claim 8, wherein the ready mode corresponds to the vehicle being plugged in and a first duty cycle being applied by the charger to the charging cable, and wherein determining whether to use the analog communications protocol or the digital communications protocol comprises:
attempting to establish a secured connection between the vehicle and the charger using the digital communications protocol;
if the secured connection is established and if the vehicle is identified using digital communications:
transitioning to standby mode;
determining payment information while in the standby mode; and
transitioning back to the ready mode in response to determining the payment information.

12. The method of claim 8, wherein the ready mode corresponds to the vehicle being plugged in and a first duty cycle being applied by the charger to the charging cable, and wherein determining whether to use the analog communications protocol or the digital communications protocol comprises:
attempting to establish a secured connection between the vehicle and the charger using the digital communications protocol;
if the secured connection is established and if the vehicle is identified using the digital communications protocol:
determining payment information as corresponding to the vehicle using the digital communications; and
achieving plug-and-charge (PnC) based on the payment information, wherein charging is managed with digital communications in the ready mode.

13. The method of claim 8, further comprising:
determining whether payment information has been received while in the standby mode; and
if the payment information has been received, transitioning from the standby mode to the ready mode, wherein charging is managed with analog communications in the ready mode.

14. A system for providing AC vehicle charging, the system comprising:
a charging interface configured to interact with a vehicle using a charging cable; and
control circuitry configured to:
determine a mode of communication based on a control signal transmitted over the charging cable;
determine payment information based on the mode of communication; and
cause the charging interface to charge the vehicle using the charging cable based on the payment information.

15. The system of claim 14, wherein the control circuitry is further configured to determine the mode of communication by determining whether to use analog or digital communication for vehicle-charger communications.

16. The system of claim 14, wherein the control circuitry is further configured to determine the mode of communication by:
setting a charging duty cycle at the charging interface to a first setting; and
determining whether signal level attenuation characterization (SLAC) started, wherein:
if SLAC has not started, the mode of communication comprises analog communication, and
if SLAC has started, the mode of communication comprises digital communication.

17. The system of claim 14, further comprising a communications interface linked to a network, wherein the control circuitry is further configured to determine the payment information by:
accessing a remote application over the network using the communications interface; and
receiving a remote start signal from the remote application over the network in response to payment being approved.

18. The system of claim 14, wherein the control circuitry is further configured to:
determine a classification of the vehicle, wherein if the classification matches a predetermined classification, determine the payment information by accessing the payment information from the vehicle using the charging cable.

19. The system of claim 14, further comprising a user interface configured to receive user input and generate a display, wherein the control circuitry is further configured to determine the payment information by:
identifying the vehicle as corresponding to a payment application; and
if the vehicle is identified as corresponding to the payment application, determining payment information for the vehicle by accessing the payment application.

20. The system of claim 14, wherein the control circuitry is further configured to:
determine the vehicle is coupled to a charger by the charging cable; and
transmit a first signal to the vehicle, wherein the control signal is a response to the first signal.
